(19) United States
(12) Patent Application Publication
(10) Pub. No.: US 2023/0252978 A1
(43) Pub. Date: Aug. 10, 2023

(54) SYSTEMS AND METHODS OF MATERIAL COMPLIANCE

(71) Applicant: STATE GRID LIANYUNGANG POWER SUPPLY COMPANY, Lianyungang (CN)

(72) Inventors: Lei WANG, Lianyungang (CN); Hong LI, Lianyungang (CN); Fei HAN, Nanjing (CN); Jin ZHU, Lianyungang (CN); Bin ZHOU, Lianyungang (CN); Lishan BAO, Nanjing (CN); Jiyu SHANG, Lianyungang (CN); Shaojie XUE, Nanjing (CN); Yong DAI, Lianyungang (CN); Lixiang ZHANG, Nanjing (CN); Shiyang WANG, Nanjing (CN); Hongxin YIN, Lianyungang (CN); Wei ZHOU, Lianyungang (CN); Nuan SHANG, Lianyungang (CN)

(73) Assignee: STATE GRID LIANYUNGANG POWER SUPPLY COMPANY, Lianyungang (CN)

(21) Appl. No.: 18/300,038

(22) Filed: Apr. 13, 2023

Related U.S. Application Data
(63) Continuation of application No. PCT/CN2021/087324, filed on Apr. 14, 2021.

(30) Foreign Application Priority Data
Oct. 16, 2020 (CN) 202011114979.7

(51) Int. Cl. G10L 15/08; G10L 15/04; G06F 16/48

(52) U.S. Cl. CPC G10L 15/08; G10L 15/04; G06F 16/48

(57) ABSTRACT

A material compliance system and method, which includes a call information receiving module for receiving call information, a voice labeling module for recognizing label information in the call information via voice recognition and inserting label information to form primary recording information, a voice segmentation module for segmenting the primary recording information into intermediate recording information based on the label information, a voice recognition module for converting the intermediate recording information into final text information, a voice analysis module for organizing the intermediate text information into compliance information and storing it in a database, and an output module for outputting the received compliance information.

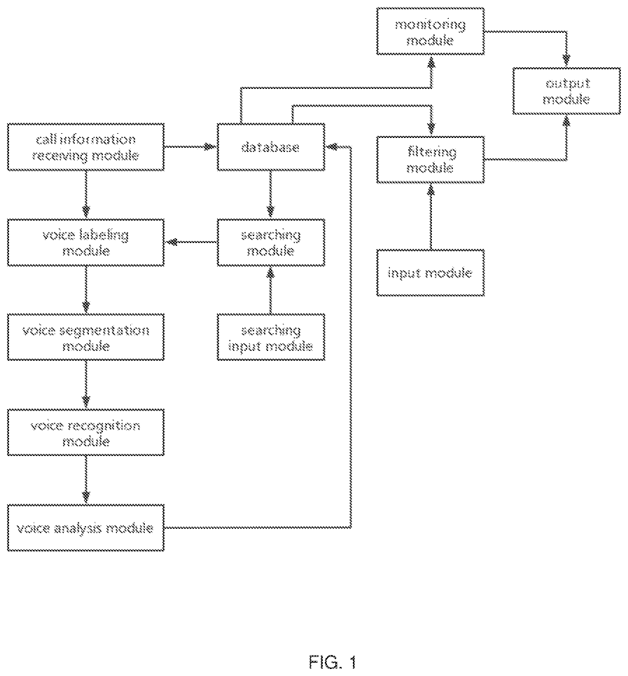

### RELATED APPLICATION

The present disclosure claims the benefit of priority to CN Patent Application No. 202011114979.7, filed Oct. 16, 2020, and entitled “Systems and methods of material compliance”, the entire contents of which is incorporated herein by reference.

### TECHNICAL FIELD

The present disclosure relates to the field of special equipment systems, and particularly pertains to systems and methods of material compliance.

### BACKGROUND

The contract compliance work is the key responsibility of the logistics center of the local authorities or municipal bureau, and the material arrival management is the core content of the contract compliance work. The existing material arrival workflow is as follows: according to the supply contract, a staff worker in the logistics center will generate paper version of the material arrival notification, scan the notification, send it to the supplier by e-mail, and then call the supplier to confirm; the supplier receives the material arrival notification, print out the notification to sign signature and affix a seal, and then scan it and email it to the logistics center staff.

However, in the actual work process, the relevant staff of the logistics center often supervise a large number of valid material contracts in the same period. Due to the large amount of material contracts, the risk of omission of the notification is relatively high. Moreover, from time to time, the agreed deadline for delivery and warehousing of corresponding materials will expire, so the staff need to continuously check all the material contracts every day or two days for verification. When checking the above material contracts, the staff workers have to call the supplier frequently to get confirmation. Mistakes and omissions may occur in the recording of the content of the call after each call is completed, and it may cause visual fatigue. Not only the work efficiency is relatively low, but the error rate is relatively high, which is not conducive to efficient and high-quality supervision of the compliance of the material contracts.

Therefore, it is necessary to provide a material compliance system and method that can automatically organize the recordings between the staff of logistics centers and suppliers.

### SUMMARY

The present disclosure provides a material compliance system, which solves the problem in the present technologies and scenarios, which is that errors and omission may occur in the communication record between the staff and the suppliers as the content of the communication is manually recorded, and a large amount of recording work will cause visual fatigue to the users after the calls complete.

The primary solution of the present disclosure is that a material compliance system includes a call information receiving module, a voice labeling module, a voice segmentation module, a voice recognition module, a voice analysis module, a database, and an output module.

The call information receiving module receives call information, and the call information includes contact person information, contact time information, and original recording information;

The voice labeling module receives the call information sent by the call information receiving module, recognizes the original recording information in the call information by voice recognition, and inserting flag information corresponding to the label information, when there is preset label information in the original recording information, into the original recording information to form primary recording information, and then associates the contact person information, contact time information, and primary recording information in the call information, and then send the information to the voice segment module;

The voice segment module receives the contact person information, contact time information, and primary recording information sent by the voice labeling module, segments the primary recording information according to the flag information to form intermediate recording information containing the label information, associates multiple intermediate recording information that come from the same primary recording information, and sends the contact person information, contact time information, and multiple intermediate recording information to the voice recognition module;

The voice recognition module receives the contact person information, contact time information, along with the multiple intermediate recording information sent by the voice segment module, converts the intermediate recording information into final text information, and associates the contact person information, contact time information, and the multiple intermediate recording information that originally belonging to the same primary recording information, and then send the information to the voice analysis module;

The voice analysis module receives contact person information, contact time information, and a plurality of final text information containing label information sent by the voice recognition module, organizes the final text information to obtain compliance information, and classifies the compliance information according to the the classifications of the flag information corresponding to the label information of the compliance information, and stores the compliance information in different areas of the database according to the classifications of different compliance information;

The output module outputs the received compliance information.

The benefit technical effect of the basic scheme is: the staff workers segment the original recording information of the original call information by setting the label information, and then associates the segmented voice with the label information. Therefore, comparing with the existing technologies, in which the staff workers can't determine if the information on the notification is consistent with the conformation of the suppliers on the phone call until they hear the entire recording when verifying the material compliance information. In the present disclosure, the staff workers could determine the consistency between the information of the notification and the confirmation from the suppliers on telephone by merely listening to the voice segmentation that corresponds to the label information. Simultaneously, the present disclosure converts the segmented intermediate recording information into texts, which is convenient for the staff workers to verify whether the notification in the material compliance contract is consistent with the content of the suppliers' phone call when it is inconvenient to listen to the voice.

Additionally, in the present disclosure, one classification of flag information can correspond to multiple different label information, and the classifications of the flag information correspond one to one to the classifications of compliance information. According to the content information and contact time information in the final text information, the voice analysis module calculates the corresponding plan/implementation time of the final text information and associates the obtained time with the final text information to obtain the compliance information. The plan/implementation time is the compliance time, and the type of the compliance information is obtained according to the type of the flag information corresponding to the label information in the compliance information, and then the compliance information is stored according to the classification results of the compliance information. There can only be one type of compliance information in an area in the database, and the types of the compliance information in different areas are different.

Therefore, in this present disclosure, the recorded conversations between the staff workers and the suppliers are segmented into different sections, and the sections are organized and classified for storage, achieving fragmentation and classification of the entire big data. Compared with the existing technology of directly storing complete recorded conversations, this disclosure requires lower database requirements, which is conducive to the storage of the entire recorded conversations, and also facilitates staff workers to analyze and process key sections in the future.

Furthermore, the call information receiving module also sends the received call information to the voice labeling module in sequence.

The technical beneficial effect of the present disclosure is that in this disclosure, upon the call information has been received, the call information is separated and sent to the voice labeling module in sequence according to the time the call information being received. Compared with the manual arrangement by staff workers to input into the voice labeling module, this present disclosure does not require manual operation by staff workers and automatically separates various call information.

Furthermore, the present system also includes a searching module and a searching input module.

The database is also used to store call information.

The search input module inputs contact person information and contact time information to the searching module.

The search module retrieves the corresponding call information from the database based on the contact person information and the contact time information input by the searching input module and sends the call information to the voice labeling module.

The technical beneficial effect of the present disclosure is that considering that there are multiple logistics staff workers, the call information receiving module simultaneously receives original recording information sent by multiple staff workers' client ends, and in the primary technology, the call information receiving module sends multiple original recording information to the voice labeling module after receiving original recording information sent by multiple staff workers' client ends, which may cause interference and affect the voice labeling module's ability to distinguish the content in each original recording information during the communication process. Therefore, this present disclosure proposes to first send multiple original recording information to the database for storage, and then let the staff workers manually control the searching module to sequentially send each call information containing original recording information to the voice labeling module, which allows the voice labeling module to process the original recording information in sequence and avoid interference between the original recording information.

At the same time, the call information is stored in the database as an archive to avoid the problems that errors appear in the voice labeling module, voice segmentation module, and voice recognition module, and staff workers cannot verify at all.

Furthermore, the system includes a label input module, which is used to send label information to the voice labeling module.

The technical beneficial effect of the present disclosure: in this scheme, the label information is set by the label input module, and staff can set multiple label information that is suitable for the staff workers' own needs. Compared to the existing technology, the present disclosure allows for greater variation in label information and offers staff workers more freedom to cut the original recording information according to their needs.

Furthermore, the present disclosure involves inserting the flag information into the original recording information to form primary recording information. Specifically, the corresponding flag information is obtained based on the existing label information in the original recording information, and the flag information is inserted into the byte of the voice pause before the label information in the original recording information to form primary recording information.

Furthermore, the steps of inserting the flag information into the original recording information to form primary recording information are as below:

extracting the corresponding flag information from the label information in the original recording information, locating the segment of the original recording information to which the label information belongs, and inserting the flag information corresponding to the label information at both ends of the segment to form the primary recording information.

Furthermore, the steps of forming the intermediate recording information by segmenting the primary recording information according to the flag information, specifically comprising: cutting out the flag information from the primary recording information to obtain multiple intermediate recording information, wherein the intermediate recording information includes the label information.

Furthermore, the steps of organizing the final text information and obtaining the compliance information, and sending the compliance information to the database for storage, which specially includes:

finding the contact time information corresponding to the final text information;

identifying the classification of the flag information corresponding to the label information in the final text information;

analyzing the time description part and the event description part in the final text information, calculating the compliance time based on the time description part and the contact time information;

associating the compliance time, the event description part in the final text information, the contact person information corresponding to the final text information, the contact time information corresponding to the final text information, and the label information in the final text information to form a compliance information; classifying the compliance information according to the classification of the flag information corresponding to the label information in the compliance information, and storing the compliance information in different areas of the database according to the classification.

The compliance information is divided into two classifications: plan information and implementation information. The database is divided into a plan area and an implementation area, wherein the plan area stores plan information, and the implementation area stores implementation information.

Furthermore, the system also includes a monitoring module.

The monitoring module retrieves the plan information and implementation information within the preset time range in the database and compares the plan information and the implementation information. When there is no corresponding implementation information exists, the plan information will be sent to the output module.

The technical beneficial effects: in this present scheme, the monitoring module screens out the plan information that has no corresponding implementation status within the preset time range and sends the plan information to the output module for output. It facilitates staff workers to understand the situation of the plans that need to be implemented, which is conducive to timely prompt suppliers to carry out corresponding implementation work.

Furthermore, the monitoring module associates the plan information with the implementation information, and the associated plan information and implementation information are summarized as a summary information, and the summary information is then sent to the output module.

The technical beneficial effect: in this present scheme, the monitoring module selects the plan information and implementation information within the preset time range and combines them into a summary information. Then, the summary information is sent to the output module for output. This makes it easy for staff workers to understand the logistics operation status within the preset time period and facilitates their work summary.

Furthermore, the monitoring module retrieves the plan information and implementation information within a preset time range from the database and then compare the plan information with the implementation information. When there is no implementation information corresponding to plan information exists, extracting the compliance time in the plan information corresponding to the implementation information. When the difference between the compliance time and the current time point is within a preset difference range, the plan information is sent to the output module.

The technical beneficial effect: in the present scheme, the monitoring module filters out the plan information that is within a preset time range and within a preset difference range from the current time point but not having corresponding implementation information, and then sends the plan information to the output module for output. This facilitates the understanding of staff that there are plan information within the preset difference range from the current time point and without corresponding implementation behavior, which helps staff to prompt suppliers to implement relevant plans in a timely manner before the deadline.

Furthermore, the input module is used to send input information to the filtering module. The input information includes at least one of contact person information, preset label information, and contact time information.

The filtering module filters out corresponding compliance information from the database based on the input information and send the compliance information to the output module.

The technical beneficial effect: in the present scheme, users can filter and output compliance information in the database through the input module. For example, if the input information is “Customer A, plan, August 2020”, then the compliance information found by the filtering module represents the shipping plan information of Customer A in August 2020. Therefore, the filtering module of this scheme performs accurate filtering on the information in the database.

Furthermore, the output module includes a display unit and a communication unit. The display unit displays compliance information, and the communication unit connects to a printer.

The technical beneficial effect: in this scheme provides two output methods, which are displaying compliance information directly through the display unit, and printing compliance information via a printer.

The present disclosure also provides a method for material compliance, which relies on the above material compliance system. The method comprises the following steps: S1, the call information receiving module receives call information, sends the call information to the voice labeling module, and stores the call information in the database;

S2, the voice labeling module retrieves the flag information corresponding to the label information in the original recording information through voice recognition of the call information and then inserts the flag information into the original recording to form primary recording information. The label information is sent to the voice labeling module by the label input module.

S3, the voice segmentation module cuts the flag information from the primary recording information, obtaining multiple intermediate recording information that originally belonged to the same primary recording information.

S4, the voice recognition module converts the intermediate recording information into final text information.

S5, the voice analysis module arranges the final text information to obtain compliance information, and stores the compliance information in different areas of the database.

S6, the monitoring module retrieves the plan information and implementation information from the database within the preset time range, performs preset operations, and sends the corresponding result information of the preset operations to the input module.

S7, the input module sends input information to the filtering module, and the input information includes at least one of the contact person information, preset label information, and contact time information. The filtering module filters out the corresponding compliance information from the database based on the input information and sends the compliance information to the output module.

S8, the output module receives the plan information and/or summary information sent by the monitoring module and outputs the plan information and/or summary information. The output module also receives the compliance information sent by the filtering module and outputs the compliance information.

In S1, the call information receiving module sends the call information to the voice labeling module/information. The specific process is as below: the call information receiving module sends all received call information to the database for storage; the searching input module inputs the contact person information and contact time information; the searching module retrieves the corresponding call information from the database according to the contact person information and contact time information inputted by the searching input module, and sends the call information to the voice labeling module.

In S2, the flag information is inserted into the original recording to form primary recording information. The specific process is: inserting the flag information into the byte of the voice pause before the label information in the original recording information, to form the primary recording information.

Alternatively, in S2, the process of inserting the flag information into the original recording information to form primary recording information is as below: finding the segment to which the label information of the original recording information belongs, and inserting the flag information corresponding to the label information at both ends of the segment to form primary recording information.

In S5, the speech analysis module organizes the final text information to obtain compliance information, which includes the following steps:

finding the contact time information corresponding to the final text information;

identifying the classification of flag information corresponding to the label information in the final text information;

analyzing the time and event description parts in the final text information to calculate the compliance time based on the time description and contact time information.

associating the compliance time, event description part in the final text information, contact person information corresponding to the final text information, contact time information corresponding to the final text information, and label information in the final text information to obtain the compliance information.

In S5, the voice analysis module stores the compliance information in different areas of the database, and the specific process is as follows:

classifying the compliance information according to the classifications of the flag information corresponding to the label information, and storing the compliance information into different areas of the database according to the classifications of the compliance information.

The compliance information has two classifications, namely, plan information and implementation information. The database is divided into a plan area and an implementation area. The plan area stores plan information, and the implementation area stores implementation information.

In S6, the predetermined operation is to compare the plan information with the implementation information and send the plan information to the output module when no implementation information exists.

Alternatively, in S6, the predetermined operation mentioned is to associate the plan information with the implementation information, create summary information from the associated information of the plan information and the implementation information, and send the summary information to the output module.

In S6, the predetermined operation is to compare the plan information with the implementation information and extract the compliance time from the corresponding plan information when no implementation information exists. When the difference between the compliance time and the current time is within a preset range, sending the plan information to the output module.

To Integrate the above material compliance method to form a new method, which includes the following steps:

S1, the call information receiving module receives call information and sends the call information to the voice labeling information module according to either step S1-1 or S1-2, and stores the call information in a database.

S1-1, the call information receiving module sends the call information to the voice label module. Specifically, the call information receiving module sends the call information to the voice label module in the order of receiving the call information.

S1-2, the searching input module inputs contact person information and contact time information, and the searching module retrieves the corresponding call information from the database based on the contact person information and contact time information input from the searching input module and then sends the call information to the voice labeling module.

S2, the voice labeling module extracts the flag information corresponding to the the label information in the original recording information by voice recognizing the original recording information of the call information, and according to either one of step S2-1 or S2-2, inserts the flag information into the original recording information to form primary recording information. The label information is sent to the voice labeling module by the label inputting module.

S2-1, inserting the flag information into the byte of the voice pause before the label information in the original recording information to form primary recording information.

S2-2, finding the segment to which the label information in the original recording information belongs, and inserting the flag information corresponding to the label information at both ends of the segment to form primary recording information.

S3, the voice segmentation module cuts out the flag information in the primary recording information to obtain multiple intermediate recording information that originally belonged to the same primary recording information.

S4, the voice recognition module converts the intermediate recording information into final text information.

S5, the voice analysis module organizes the final text information to obtain the compliance information according to step S5-1, and stores the compliance information in different areas of the database according to step S5-2.

S5-1, locating the contact time information corresponding to the final text information; identifying the classification of the flag information corresponding to the label information in the final text information; analyzing the time description part and event description part in the final text information, and calculating the compliance time based on the time description part and contact time information; associating the compliance time, event description part in the final text information, the contact person information corresponding to the final text information, the contact time information corresponding to the final text information, and the label information in the final text information to obtain compliance information.

S5-2: classifying the compliance information based on the classification of the flag information corresponding to the label information in the compliance information, and storing the compliance information in different areas of the database according to the classification of the compliance classification. The compliance information includes two classifications, namely plan information and implementation information. The database is divided into a plan area and an implementation area. The plan area stores plan information, and the implementation area stores implementation information.

S6: The monitoring module retrieves the plan information and implementation information from the database within the preset time range, and performs at least one operation of S6-1, S6-2, or S6-3.

S6-1: comparing the plan information with the implementation information. When there is the corresponding implementation information is null, sending the plan information to the output module.

S6-2: associating the plan information with the implementation information, and the associated plan information and implementation information form the summary information, which is sent to the output module.

S6-3: comparing the plan information with the implementation information. When the implementation information is null, extracting the compliance time from the plan information corresponding to the implementation information. If the difference between the compliance time and the current time point is within the preset difference range, sending the plan information to the output module.

S7: The input module sends input information, including at least one of contact person information, preset label information, and contact time information, to the filtering module. The filtering module filters out the corresponding compliance information from the database based on the input information and sends the compliance information to the output module.

S8: The output module receives plan information and/or summary information sent by the monitoring module, and outputs plan information and/or summary information. The output module receives the compliance information sent by the filtering module and outputs the compliance information.

### BRIEF DESCRIPTION OF THE DRAWING(S)

FIGURE is a schematic diagram of a module embodiment of a material compliance system according to the exemplary embodiments of the present disclosure.

### DETAILED DESCRIPTION

More detailed explanation is provided through specific implementation methods as below.

The specific implementation is shown in the FIGURE.

A material compliance system comprises a call information receiving module 101, a voice labeling module 102, a voice segmentation module 103, a voice recognition module 104, a voice analysis module 105, a database 106, an output module 112, a searching module 107, a searching input module 108, an input module 111, and a filtering module 110.

The call information receiving module 101 receives call information, which includes contact person information, contact time information, and original recording information. The call information is then sent to the database 106 or sent to the voice labeling module 102 in sequence of receiving the call information.

The searching input module 108 inputs contact person information and contact time information to the searching module 107.

The searching module 107 retrieves corresponding call information from the database 106 based on the contact person information and contact time information input by the searching input module 108. The retrieved call information is then sent to the voice labeling module 102.

The voice labeling module 102 receives the call information sent by the searching module 107 or the call information receiving module 101. The voice labeling module 102 recognizes the original recording information in the call information and inserts flag information into the original recording information to form primary recording information when preset label information exists in the original recording information. The voice labeling module 102 then associates the contact person information, contact time information, and primary recording information in the call information and sends the associated information to the voice segmentation module 103.

The voice segmentation module 103 receives the contact person information, contact time information, and primary recording information sent by the voice labeling module 102. The voice segmentation module 103 segments the primary recording information into intermediate recording information containing label information based on the flag information and associates multiple intermediate recording information originating from the same primary recording information. The contact person information, contact time information, and multiple intermediate recording information are then sent to the voice recognition module 104.

The voice recognition module 104 receives the contact person information, contact time information, and multiple intermediate recording information sent by the voice segmentation module 103, converts the intermediate recording information into final text information, and sends the contact person information, contact time information, and multiple final text information containing the label information to the voice analysis module 105.

The voice analysis module 105 receives the contact person information, contact time information, and multiple final text information with the label information sent by the voice recognition module 104, organizes the final text information to obtain the compliance information, and classifies the compliance information according to the type of flag information corresponding to the label information in the compliance information, and then stores the compliance information in different areas of the database 106 according to the classifications of different compliance information.

The monitoring module 109 retrieves the plan information and implementation information in the database 106 within the preset time range and compares the plan information with the implementation information. If no implementation information exists, i.e. the implementation information is null, the plan information will be sent to the output module 112. The monitoring module 109 also retrieves the plan information and implementation information in the database 106 within the preset time range, associates the plan information and implementation information, and the associated plan information and the implementation information forms the summary information, which is then sent to the output module 112. Furthermore, the monitoring module 109 retrieves the plan information without corresponding implementation information and extracts the compliance time from the plan information. If the difference between the compliance time and the current time point is within the preset difference range, the plan information will be sent to the output module 112.

The input module 111 sends input information to the filtering module 110. The input information includes at least one of contact person information, preset label information, and contact time information.

The filtering module 110 filters the corresponding compliance information from the database 106 based on the input information and sends the compliance information to the output module 112.

The output module 112 receives the compliance information sent by the monitoring module 109 and the filer module, and outputs the compliance information.

This implementation has the following key points during its execution:

(1) The call information receiving module 101 is connected to the telephones of various staff workers. When the staff workers communicate with the suppliers on the phones, the recordings of the staff workers' telephones are made. These recordings, together with the contact person information and contact time information, are used as call information, which is sent to the call information receiving module 101.

(2) The call information receiving module 101 receives the call information sent by the telephones of multiple staff workers and sends the call information to the voice labeling module 102. Considering that different voice labeling module 102 receiving multiple call information at the same time will cause interference, or a voice labeling module 102 cannot receive multiple call information at one time, the present disclosure solution also provides two rules for the call information receiving module 101 to send call information, respectively:

(2.1) Each call information received by call information receiving module 101 is sent to the call recording area of the database 106, and the staff workers input the contact person information and contact time information via the searching input module 108; and the searching module 107 retrieves the call information corresponding to the contact person information and contact time information from the database 106, and the call information is sent to the voice labeling module 102. In this present disclosure solution, the staff workers accurately find the corresponding call information in the database 106 via the searching input module 108 and the searching module 107, and sends the call information to the voice labeling module 102 for separate processing, avoiding the interference of other call information in the same period, and at the same time it is also convenient for staff to accurately analyze call recordings.

Moreover, after a large amount of call information has been input, the staff can manually control the input content of the searching input module 108, and separately propose and send the corresponding call information to the voice labeling module 102. Considering that the staff worker can only input the same type of contact person information and contact time information in the searching input module 108, so this solution also realizes the separation of call information, and according to the order of user input, to input to the voice labeling module 102 successively.

At the same time, the database 106 stores call information as an archive to avoid errors in the voice labeling module 102, voice segmentation module 103, and voice recognition module 104, which cannot be verified by the staff workers.

(2.2) The call information receiving module 101 sorts the received call information, and the sorting priority is according to the time of receiving the call information, and then according to the order of the first letter of the contact person. Compared with manually arranging input to the voice labeling module 102 by staff workers, the present disclosure solution does not require manual operation by staff workers, and automatically separates each call information instead.

(3) The voice labeling module 102 extracts original recording information from call information via voice recognition. When there are preset labeling information in the original recording information, the voice labeling module 102 inserts the flag information into the original recording to form primary recording information. The working process of the voice labeling module 102 includes: S1, extracting the original recording information from the call information; S2, determining whether there are preset label information in the original recording information, if so, proceed to S3; S3, the voice recognition module 104 finds the corresponding flag information according to the preset label information; S4, the voice input module inserts the flag information into the original recording information between the section with label information and the previous section, forming primary recording information; S5, the voice labeling module 102 associates the primary recording information with contact person information and contact time information, which be sent to the voice segmentation module 103.

In S1, the call information includes contact person information, contact time information, and original recording information. Therefore, the operation of S1 can be completed. For example, call information of (3.1.1) includes “P, August 2020, Voice K”, wherein contact person information is “P”, contact time information is “August 2020”, and original recording information is “Voice K”.

In S2, the voice recognition module 104 recognizes whether there is preset label information in the original recording information. The specific implementation can refer to the voice recognition function in existing technologies, such as Xiaomi's Xiao Ai assistant which recognizes commands according to voice. Furthermore, there are two sources for the label information in S2: (3.2.1), the system manufacturer presets the label information, and cannot be changed; (3.2.2), the label information is input by the label inputting module.

Considering the current technologies, suppliers often speak a lot of irrelevant content during telephone communication with staff workers, causing a lot of irrelevant work for the staff workers to register and verify the supplier's plan and implementation information. Therefore, the present disclosure aims at specifically distinguishing between plan information and implementation information in the communication between suppliers and staff. In the present disclosure, the label information is divided into two classifications: plan and implementation. The plan labels typically represent segments related to the plans, such as “plan”, “prepare”, “will be . . . on”, etc. The implementation labels generally represent segments related to implementations, such as “already”, “so far”, etc.

In S3, the voice recognition module 104 finds the corresponding flag information based on the label information. The flag information is divided into two classifications: a represents planning, and b represents implementation. Each label information corresponds to a unique flag information, and each flag information corresponds to at least one label information. There are at least two classifications of label information.

In S4, the voice recognition module 104 inserts the flag information into the original recording information to form the primary recording information. There are two methods for inserting the flag information:

(3.4.1) The flag information is inserted into the byte of the voice pause before the label information in the original recording information, forming a primary recording information. For example: Based on (3.1.1), assuming that the content of the original recording information K is “Hello! •I plan to ship one hundred parts to Beijing in two months, •at this time twenty of them have already been shipped, •we will take it slowly later, •please give us advance notice if there's an emergency.” The symbol “•” represents a pause before and after, which conforms to the rules of speech expression for the staff workers and other person. The label information “plan” and “already” are identified in the original recording information, and the corresponding flag information for these two pieces of the label information are a and b.

The primary recording information with the inserted flag information is “Hello •a I plan to ship on hundred parts to Beijing in two months •b at this time twenty of them have already been shipped we will take it slowly later •please give us advance notice if there's an emergency”.

(3.4.2) Identifying the segments in the original recording that corresponds to the label information and insert the corresponding flag information at the beginning and end of each segment to form the primary recording information. Using the example from (3.4.1), the primary recording information with inserted flag information would be, recording of: “Hello •a I plan to ship one hundred parts to Beijing in two months a•b at this time twenty of them have already been shipped •b we will take it slowly later •please give us advance notice if there's an emergency”.

The voice segmentation module 103 receives contact person information, contact time information, and primary recording information from the voice labeling module 102. The voice segmentation module 103 uses the flag information to segment the primary recording information and remove the flag information to obtain multiple intermediate recording information. The voice segmentation module 103 then associates the contact person information, contact time information, and intermediate recording information that belong to the same primary recording information and sends the information to the voice recognition module 104.

(4.1) For the primary recording information formed according to the steps in the example of (3.4.1), there are three voice segments after segmentation: “Hello”, “I plan to ship 100 parts to Beijing in two months”, and “this time twenty of them has been shipped •and we'll take it slow for the rest •please let us know in advance •if there's an emergency”. In the three voice segments, the recording segment of “I plan to ship 100 parts to Beijing in two months” containing the “plan” label information and the recording segment of “We'll take it slow for the rest •please let us know in advance •if there's an emergency” containing the label information “already” are both treated as intermediate recording information.

Therefore, the information sent from the voice segmentation module 103 to the voice analysis module 105 is: “P (representing contact person information), August 2020 (representing contact time information), ‘I plan to ship 100 parts to Beijing in two months’ (voice recording, representing the first intermediate recording information), ‘We'll take it slow for the later please let us know in advance if there's any urgency’ (voice recording, representing the second intermediate recording information).”

(4.2) upon the primary recording information is segmented according to the steps outlined in (3.4.2), there are four voice segments: “Hello,” “I plan to ship 100 parts to Beijing two months later”, “at this time twenty of them have already been shipped this time”, and “We'll take it slow later •please let us know in advance •if there's any urgency”. Among these four segments, “I plan to ship 100 parts to Beijing two months later” containing the “plan” label and “at this time twenty of them have already been shipped” containing the “already” label are considered as intermediate recording information.

5) The voice recognition module 104 receives contact person information, contact time information, and multiple intermediate recording information sent by the voice segmentation module 103, converts the intermediate recording information into final text information, and sends the contact person information, contact time information, and multiple final text information to the voice analysis module 105. The function of the voice recognition module 104 is to convert voice into text, for example, “I plan to ship one hundred parts to Beijing in two months (voice recording, representing the first intermediate recording information)” is converted into “I plan to ship one hundred parts to Beijing in two months (text, representing the first final text information)”. As voice-to-text technology is already mature, this solution will not go into too much detail on the principles of voice-to-text.

(6) The voice analysis module 105 receives the contact person information, contact time information, and multiple final text information with label information sent by the voice recognition module 104. The voice recognition module 104 organizes the final text information to obtain compliance information and sends the compliance information to the database 106 for storage. There are two classifications of compliance information, namely planning information and implementation information, which are classified based on the label information.

The compliance information is obtained by organizing the final text information as follows: S6-1, filtering the contact time information corresponding to the final text information; S6-2, identifying the classification of the flag information corresponding to the label information in the final text information; S6-3, analyzing the time description part and event description part in the final text information, and calculating the compliance time based on the time description part and contact time information; S6-4, obtaining the compliance information based on the content of S6-1 to S6-3, classifying the compliance information based on the classification of the flag information corresponding to the label information in the compliance information, associating the classified compliance information, contact person information, and contact time information, and send the information to the database 106 for storage.

In S6-1, since the final text information corresponds one-to-one or uniquely with the intermediate recording information, and one intermediate recording information corresponds to only one primary recording information, one primary recording information corresponds to a unique original recording information, which is associated with the contact person information and contact time information. Therefore, it is feasible to find the corresponding contact time information through the final text information in this step. Taking (4.1) as an example, according to the final text information “I plan to ship one hundred parts to Beijing in two months” (text version), the corresponding contact time can be traced back to “August 2020”.

In S6-2, since each intermediate recording information contains label information (voice version), after voice-to-text conversion, the final text information naturally contains label information (text version), and the label information (voice version) and the label information (text version) are different expressions of one same information. Therefore, in this step, it is feasible to extract the label information from each final text information. After obtaining the label information, it can be known that it corresponds to a unique flag information, and then the classification of the flag information can be obtained. Taking (4.1) as an example again, according to the final text information “I plan to ship one hundred parts to Beijing in two months” (text version), the label information “plan” can be extracted, and the corresponding flag information for this label information “plan” is a, which represents the classification of flag as “plan”.

In S6-3, the time and event description parts of the final text information are analyzed to calculate the compliance time based on the contact time information. Taking (4.1) as an example, in the text version of “I plan to ship one hundred parts to Beijing in two months,” the time description part “in two months” and the event description part “ship one hundred parts to Beijing” are extracted. Based on the time description part “in two months” and the contact time information “August 2020,” the compliance time is calculated to be “October 2020.”

In S6-4, based on S6-3, the compliance time “October 2020”, the event description part “shipping one hundred parts to Beijing” in the final text information, the corresponding contact person information “P”, the corresponding contact time information “August 2020”, and the label information “plan” are associated as compliance information. Based on the classification of flag information corresponding to the label information in the compliance information, the compliance information is classified. Thus, the classification of the above compliance information is a plan information.

The database 106 is divided into a plan area and an implementation area. The above compliance information belonging to the plan information is stored in the plan area of the database 106, while other compliance information belonging to the implementation information is stored in the implementation area of the database 106.

In (7), the staff worker sets a time range T, and the monitoring module 109 retrieves all compliance information within the time range T. The compliance information classified as plan information is compared with the compliance information classified as implementation information, and based on the comparison results, the following three actions can be taken:

(7.1) when the corresponding implementation information for a plan information cannot be found, the plan information and the current time will be sent to the output module 112. The monitoring module 109 will filter out the plan information without corresponding implementation within the preset time range, and send the plan information to the output module 112 for output, which is beneficial for staff to understand the situation of plans awaiting implementation and to prompt suppliers to carry out corresponding implementation work in a timely manner.

In (7.2), the plan information and implementation information originating from the same original recording information are associated, and the associated plan information and implementation information are merged into a summary information. The managed summary information is sent to the output module 112 for the convenience of staff to understand the logistics situation during the preset time period, and to facilitate the work summary for staff.

(7.3) When no corresponding implementation information exists for a plan information, extracting the compliance time from the plan information. If the difference between the compliance time and the current time point is within the preset difference range, sending the plan information to the output module 112.

For example, for a plan information that cannot find corresponding implementation information, “October 2020” (compliance time), “ship one hundred parts to Beijing” (event description in the final text information), “P” (contact person information corresponding to the final text information), “August 2020” (contact time information corresponding to the final text information), “plan” (label information), extracting the compliance time from the plan information, which is October 2020. The preset difference range is denoted by “t”, which can be set by the system provider or by the user through the client end to communicate with the monitoring module 109 to remotely input the preset difference range. Combining the compliance time of October 2020 with the current time of Sep. 15, 2020, the difference between the compliance time and the current time is calculated. The calculated difference is compared with the preset difference range “t”, and when the difference is within the preset difference range, the plan information is directly sent to the output module 112. This is convenient for the staff workers to understand the plan information that is within the preset difference range from the current time and there is no corresponding implementation behavior. This is also convenient for the staff workers to prompt the supplier to timely implement the relevant plan before the plan deadline.

In (8), the input module 111 sends input information, including at least one of the contact person information, preset label information, and contact time information, to the filtering module 110. The filtering module 110 is used to filter the corresponding compliance information from the database 106 based on the input information and send the compliance to the output module 112.

Users can filter and output the compliance information in the database 106 through the input module 111. For example, if the input information is “customer A, plan, August 2020”, the filtering module will retrieve the compliance information that represents the planned shipment of customer A in August 2020. Therefore, the filtering module of this solution performs accurate search of information in the database 106.

(9) The output module 112 receives the plan information and/or implementation information, i.e., compliance information, sent by the monitoring module 109 and outputs the compliance information in the following ways:

(9.1) The output module 112 is connected to an LED display screen and displays the received compliance information from the monitoring module 109 on the screen.

(9.2) The output module 112 is telecommunication connected to the the staff workers' mobile phones or other client devices. The module sends the received compliance information to the staff workers' mobile phones or other client devices. Specifically, if (7.1) is executed, the output module 112 sends the preset time range information and the plan information to the staff workers' mobile phones or other client devices to inform them that the plan information has not been implemented within the preset time range. If (7.2) is executed, the output module 112 sends the preset time range information and the summary information containing both plan and implementation information to the staff workers' mobile phones or other client devices. This includes sending the preset time range information and the two interrelated compliance information to inform staff workers of the overall plan and compliance status within the preset time range. If (7.3) is executed, the output module 112 sends the preset time range information, plan information, and the time difference information, which is the difference between the compliance time in the plan information and the current time, to the workers' mobile phones or other client devices. This notifies workers that the content corresponding to the plan information is about to expire and has not been implemented.

The present disclosure also provides a method for material compliance that relies on the aforementioned material compliance system, comprising the following steps:

S1, the call information receiving module 101 receives call information and sends the call information to the voice labeling information module, and stores it in the database 106.

S2, the voice labeling module 102 recognizes the original recording information in the call information using voice recognition and searches for the corresponding flag information of the label information in the original recording information and inserts the flag information into the original recording to form primary recording information. The label information is sent to the voice labeling module 102 by the label input module.

S3, the voice segmentation module 103 removes the flag information from the primary recording information, obtaining multiple intermediate recording information belonging to the same primary recording information.

S4, the voice recognition module 104 converts the intermediate recording information into final text information.

S5, the voice analysis module 105 organizes the final text information to obtain compliance information according to step S5-1, and stores the compliance information in different areas of the database 106 according to step S5-2.

S5-1, locating the contact time information corresponding to the final text information; identifying the classifications of the flag information corresponding to the label information in the final text information; analyzing the time description and event description parts in the final text information, and calculating the compliance time based on the time description part and the contact time information; associating the compliance time, the event description part in the final text information, the contact person information corresponding to the final text information, the contact time information corresponding to the final text information, and the label information in the final text information to obtain the compliance information.

S5-2, classifying the compliance information according to the classification of flag information corresponding to the label information in the compliance information, and store the compliance information in different areas of the database 106 according to the classification; there are two classifications of compliance information, namely plan information and implementation information, and the database 106 is divided into plan area and implementation area, where the plan area stores plan information, and the implementation area stores implementation information.

S6, the monitoring module 109 retrieves the plan information and implementation information from the database 106 within the preset time range and proceeds with at least one operation in S6-1, S6-2, or S6-3.

S6-1, comparing the plan information with the implementation information, and when there is no implementation information corresponding to the plan information, sending the plan information to the output module 112.

S6-2, associating the plan information with the implementation information, and wherein the associated plan information and implementation information become summary information, and sending the summary information to the output module 112.

S6-3, comparing the plan information with the implementation information, and when there is no implementation information corresponding to the plan information, extracting the compliance time from the corresponding plan information, and when the difference between the compliance time and the current time is within the preset difference range, sending the plan information to the output module 112.

S7, the input module 111 sends input information, which includes at least one of the contact person information, preset label information, and contact time information, to the filtering module 110. The filtering module 110 filters out corresponding compliance information from the database 106 based on the input information and sends the compliance information to the output module 112.

S8, the output module 112 receives the plan information and/or summary information sent by the monitoring module 109, and outputs the plan information and/or summary information. The output module 112 receives the compliance information sent by the filtering module, and outputs the compliance information.

The skilled person in the art should understand that the embodiments of the present disclosure can be provided as methods, systems, or computer program products. Therefore, the embodiments of the present disclosure can be implemented in the form of completely hardware embodiments, completely software embodiments, or combined software and hardware embodiments. Furthermore, the embodiments of the present disclosure can be implemented in the form of a computer program product stored on one or more computer-readable storage media (including but not limited to magnetic disk storage, CD-ROM, optical storage, etc.).

The present disclosure is described with reference to a flowchart and/or block diagram illustrating methods, apparatus (systems), and computer program products according to embodiments of the present application. It should be understood that each flow process and/or block illustrated in the flowchart and/or block diagram, and combinations thereof, can be implemented by computer program instructions. These computer program instructions can be provided to a general-purpose computer, special-purpose computer, embedded processor or other programmable data processing device to produce a machine that, when executed by a computer or other programmable data processing device, performs the specified functions of the flowchart or block diagram.

The computer program instructions may also be stored in a computer-readable memory that can guide a computer or other programmable data processing device to work in a particular way, such that the instructions stored in the computer-readable memory produce an apparatus including an instruction device that implements the functions specified in the flowchart or block diagram.

These computer program instructions can also be loaded onto a computer or other programmable data processing device, such that a series of operating steps are performed on the computer or other programmable device to produce a computer implemented process, whereby the instructions executed on the computer or other programmable device provide steps for implementing the functions specified in one or more processes of the flowchart and/or one or more boxes of the block diagram.

The embodiments of the present disclosure have been described above. The specific structures and features known in the art are not described in detail here. Ordinary skilled person in the art knows all the common technical knowledge in the technical field to which the disclosure belongs before the filing date or priority date, can learn all existing technologies in the field, and have the ability to apply conventional experimental means before that date. Ordinary skilled persons in the art can improve and implement the present invention based on the guidance provided in the present disclosure and their own abilities, and some typical known structures or methods should not be obstacles for ordinary skilled persons in the art to implement the present disclosure. It should be pointed out that for those skilled in the art, various modifications and improvements can be made without departing from the structure of the present disclosure, which should also be regarded as the scope of protection of the present disclosure, and these will not affect the effect of the implementation and utility of the patent of the present disclosure. The scope of protection required by the present disclosure shall be determined based on the content of its claims, and the specific embodiments described in the specification can be used to explain the content of the claims.

1. A material compliance system, comprising: a call information receiving module, a database, and an output module, characterized in that further comprising a voice labeling module, a voice segmentation module, a voice recognition module, and a voice analysis module;
wherein the call information receiving module receives call information, which includes original recording information;
the voice labeling module receives the call information sent by the call information receiving module, recognizes voice of the original recording information of the call information, and when there is preset label information in the original recording information, controls to insert flag information corresponding to the preset label information into the original recording information to form primary recording information, and sends the primary recording information to the voice segmentation module;
the voice segmentation module receives the primary recording information sent by the voice labeling module, segments the primary recording information according to the flag information to form intermediate recording information containing the label information, and then sends the intermediate recording information to the voice recognition module;
the voice recognition module receives more than one of the intermediate recording information sent by the voice segmentation module, converts the intermediate recording information into final text information, and sends the final text information to the voice analysis module;
the voice analysis module receives the final text information sent by the voice recognition module, organizes the final text information to obtain compliance information, classifies the compliance information according to classifications of the flag information corresponding to the label information in the compliance information, and stores the compliance information in different areas of the database according to the classifications of different compliance information; and
the output module outputs the received compliance information.

2. The system of claim 1, wherein the call information further includes contact person information and contact time information, wherein the contact person information, the contact time information, and the original recording information associate with each other;
the voice labeling module associates the contact person information, the contact time information, and the primary recording information formed by the original recording information, and then sent the information to the voice segmentation module;
the voice segmentation module receives the primary recording information, the contact person information, and the contact time information sent by the voice labeling module, associates the contact person information, the contact time information, and the intermediate recording information formed by the primary recording information, and then sent the information to the voice recognition module;
the voice recognition module receives the intermediate recording information, the contact person information, and the contact time information sent by the voice segmentation module, associates the contact person information, the contact time information, and the final text information formed by the intermediate recording information, and then sent the information to the voice analysis module; and
the voice analysis module receives the final text information, the contact person information, and the contact time information sent by the voice recognition module, associates the contact person information, the contact time information, and the compliance information obtained by organizing the final text information, and then store the information into different areas of the database with the compliance information.

3. The system of claim 2, further comprising a searching module and a searching input module;
the database stores the call information;
the searching input module inputs the contact person information and the contact time information to the searching module; and
the searching module retrieves the call information based on the contact person information and the contact time information input by the searching input module and sends the call information to the voice labeling module.

4. The system of claim 3, further comprising a label input module, wherein the label input module sends the label information to the voice labeling module.

5. The system of claim 1, wherein inserting the flag information into the original recording information to form the primary recording information, further comprising:
obtaining the corresponding flag information based on the label information in the original recording information, and inserting the flag information into a byte of a voice pause before the label information in the original recording information, to form the primary recording information.

6. The system of claim 1, wherein inserting the label information the original recording information to form primary recording information, specially comprising:
obtaining the corresponding flag information according to the label information in the original recording information, finding the segment to which the label information in the original recording information belongs, and inserting the flag information corresponding to the label information at both ends of the segment to form the primary recording information.

7. The system of claim 6, wherein segmenting the primary recording information according to the flag information to form intermediate recording information, specially comprising:
cutting out the flag information in the primary recording information to obtain multiple intermediate recording information that belong to a same primary recording information.

8. The system of claim 2, wherein comprising obtaining the compliance information by organizing final text information, and sending the compliance information to the database for storage, specially comprising:
locating the contact time information corresponding to the final text information;
identifying the classification of the flag information corresponding to the label information in the final text information;
analyzing a time description part and an event description part in the final text information, and calculating the compliance time based on the time description part and the contact time information;
associating the compliance time, the event description part in the final text information, the contact person information corresponding to the final text information, the contact time information corresponding to the final text information, and the label information in the final text information to obtain the compliance information;
classifying the compliance information based on the classifications of the flag information corresponding to the label information in the compliance information; storing the compliance information in different areas of the database according to the classifications of the compliance information;
wherein the compliance information includes two classifications, namely, plan information and implementation information; and
the database is divided into a plan area and an implementation area; wherein the plan area stores the plan information, and the implementation area stores the implementation information.

9. The system of claim 8, further comprising a monitoring module; wherein the monitoring module retrieves the plan information and the implementation information from the database within a preset time range and compares the plan information with the implementation information; when no implementation information exists, the monitoring module sends the plan information to the output module.

10. The system of claim 9, wherein the monitoring module associates the plan information with the implementation information; the associated plan and the implementation information forms the summary information, which is sent to the output module.

11. The system of claim 9, wherein:
the monitoring module further retrieves the plan information and the implementation information from the database within the preset time range and compares the plan information with the implementation information;
when there is no implementation information, the monitoring module extracts the compliance time from the plan information corresponding to the implementation information; and
if the difference between the compliance time and a current time point is within a preset difference range, the monitoring module sends the plan information to the output module.

12. The system of claim 1, further comprising: an input module and a filtering module;
wherein the input module sends input information, including at least one of the contact person information, the preset label information, and the contact time information, to the filtering module; and
the filtering module filters out the corresponding compliance information from the database based on the input information and sends the compliance information to the output module.

13. A method for material compliance, comprising:
S1, a call information receiving module receiving call information, sending the call information to the voice labeling information module, and storing the call information in the database;
S2, a voice labeling module recognizing an original recording information in the call information via voice recognition and searching for a corresponding flag information of a label information in the original recording information and inserting the flag information into the original recording to form primary recording information; wherein, the label information is sent to the voice labeling module by a label input module;
S3, a voice segmentation module removing the flag information from the primary recording information, obtaining multiple intermediate recording information originally belonging to the same primary recording information;
S4, a voice recognition module converting the intermediate recording information into final text information;
S5, a voice analysis module organizing the final text information to obtain compliance information and storing the compliance information in different areas of the database;
S6, a monitoring module retrieving the plan information and the implementation information from the database within a preset time range and proceeding with preset operations, and storing a corresponding result of the preset operations sending to the output module;
S7, an input module sending the input information, which includes at least one of the contact person information, preset label information, and the contact time information, to a filtering module; the filtering module filtering out the corresponding compliance information from the database based on the input information and sending the compliance information to the output module; and
S8, the output module receiving the plan information and/or summary information sent by the monitoring module, and outputting the plan information and/or summary information; the output module receiving the compliance information sent by the filtering module and outputting the compliance information.

14. The method of claim 12, wherein the call information receiving module sending the call information to the voice labeling module in the S1 specially comprising:
the call information receiving module sending the received call information to the database for storage;
the searching input module inputting the contact person information and the contact time information;
the searching module retrieves the corresponding call information from the database based on the contact person information and the contact time information input by the searching input module, and sending the call information to the voice labeling module.

15. The method of claim 13, wherein the inserting the flag information into the original recording information to form the primary recording information in the S2, specially comprising:
inserting the flag information into a byte of the voice pause before the label information in the original recording information to form the primary recording information.

16. The method of claim 13, wherein the inserting the flag information into the original recording information to form the primary recording information in the S2, specially comprising:
identifying the segments in the original recording that corresponds to the label information and insert the flag information at the beginning and end of the segment to form the primary recording information.

17. The method of claim 13, wherein the voice analysis module organizing the final text information to obtain the compliance information in the S5, specially comprising:
filtering the contact time information corresponding to the final text information;
identifying the classification of the flag information corresponding to the label information in the final text information;
analyzing a time description part and an event description part in the final text information, and calculating the compliance time based on the time description part and the contact time information;
associating the compliance time, the event description part in the final text information, the contact person information corresponding to the final text information, the contact time information corresponding to the final text information, and the label information in the final text information to obtain the compliance information.

18. The method of claim 13, wherein the voice analysis module storing the compliance information in different areas of the database in the S5, specially comprising:
classifying the compliance information according to the classification of the flag information corresponding to the label information of the compliance information, and storing the compliance information into different areas of the database according to the classifications of the compliance information;
wherein the compliance information having two classifications, namely, plan information and implementation information;
the database being divided into a plan area and an implementation area; wherein the plan area stores the plan information, and the implementation area stores the implementation information.

19. The method of claim 13, wherein the predetermined operations in the S6 comprising:
comparing the plan information with the implementation information, and sending the plan information to the output module when no implementation information exists.
associating the plan information with the implementation information, obtaining the summary information based on the associated plan information and the implementation information, and sending the summary information to the output module.

20. The method of claim 13, wherein the predetermined operations in the S6 comprising:
comparing the plan information with the implementation information, and extracting the compliance time from the plan information corresponding to the implementation information when there is no implementation information;
sending the plan information to the output module when the difference between the compliance time and the current time is within a preset range.
